(19) United States
(12) Patent Application Publication
(10) Pub. No.: US 2006/0285997 A1
(43) Pub. Date: Dec. 21, 2006

(54) Plasma-modified surfaces for atomic force microscopy

(75) Inventors: Nelle Lynn Slack, Goleta, CA (US); Stephen Leonard Kaplan, San Carlos, CA (US)

Correspondence Address: MORRISON ULMAN, WOODSIDE IP GROUP 1900 EMBARCADERO ROAD SUITE 209, PALO ALTO, CA, 94303-3327, US

(73) Assignee: VEECO INSTRUMENTS, INC., Woodbury, NY (US)

(21) Appl. No.: 11/160,311

(22) Filed: Jun. 17, 2005

(51) Int. Cl. G01N 31/22

(52) U.S. Cl. 422/99

(57) ABSTRACT

A plasma process modifies substrates for use in probe microscopy of biomolecules. Substrates prepared using the process feature low surface roughness, strong attachment of biomolecules to their surface and long storage time. The process may be performed in batch mode.

### TECHNICAL FIELD

The invention relates generally to atomic force microscopy sample preparation techniques. In particular it relates to plasma modified surfaces used in atomic force microscope imaging of biomolecules.

### BACKGROUND

Atomic force microscopy (AFM) is a powerful tool for imaging objects at the nanometer length scale. Under optimal conditions, AFM images having a lateral resolution better than 1 nm and a vertical resolution of ˜0.1 nm may be obtained. High resolution measurements depend on optimized sample preparation and imaging conditions. Sample preparation is critical and is known to be a time consuming and laborious procedure.

The AFM is attractive to biologists due to its potential to image biological molecules in physiologically relevant conditions. Previously, researchers have relied on techniques such as transmission electron microscopy and protein crystallography to gain a better understanding of protein folding, conformation and activity. However, these characterization techniques cannot directly measure a protein in its physiological environment and artifacts may be introduced in image results.

AFM has the potential to elucidate properties of biological molecules in the exact environment in which they function. Further, AFM could be used to study the binding of biological molecules. A better understanding of antigen-antibody binding is critical information for miniaturizing the immunochemistry template down to the nanoscale. However, in order to successfully image these molecules and interactions with AFM, a method to immobilize biological molecules consistently, easily, and covalently onto a solid substrate needs to be invented. In the field of probe microscopy, a substrate refers to a generally flat surface onto which molecules or other sample material is placed for imaging. Immobilization of a biological molecule, in this case, refers to sufficiently tight binding of the molecule to allow repeated measurement by AFM. By repeated measurement we mean creating at least two identical images of the identical sample area, preferable many more images.

Present methods used to prepare biological molecules for AFM imaging rely on non-covalent interactions such as electrostatic or hydrophobic effects to adsorb the molecule to a substrate. Mica is a commonly used substrate due to its atomically flat surface. However, mica carries a negative surface charge due to the presence of hydroxyl groups. The negative surface charge repels many biological molecules. To circumvent this repulsive interaction, AFM users introduce monovalent or multivalent ions or a combination of both in an immobilization solution to adsorb the biomolecules to the surface via electrostatic interactions.

Extensive work has been done to optimize the use of multivalent ions in immobilization of DNA to solid substrates for DNA structure analysis and DNA-protein complex imaging with AFM. See, for example: Vesenka, Ultramicroscopy 42,1243-1249, 1992; Hansma, Science 256, 1180-1184, 1992; Bustamante, Current Opinion in Structural Biology 7, 709-716, 1997; and, Bustamante, Methods in Enzymology 12, 73-83, 1997, each of which is incorporated herein by reference. Proteins can also be immobilized through the use of the electrostatic force for AFM imaging by changing the pH of the solution used during the immobilization step. Unfortunately, the concentration of monovalent and multivalent ions in solution, for the case of DNA immobilization, and the pH of the solution, for the case of protein immobilization, can alter the structure of the biomolecule resulting in an AFM image of a non-physiologically relevant structure.

Electrostatic immobilization of biomolecules to a solid substrate has also been accomplished by silanizing mica surfaces to create positively charged amino groups at the surface. See: Lyubchenko, Proceedings of the National Academy of Sciences 94, 496-501, 1997 and Shlyakhtenko, Ultramicroscopy 97, 279-287, 2003, both of which are incorporated herein by reference. These amino groups become protonated over a wide range of pH, yielding a positively charged surface available to bind negatively charged biomolecules through electrostatic interactions. Silanization can be performed either in the vapor or fluid phase. Presently, many AFM users prepare silanized mica sheets (3-aminopropyltriethoxy silane functionalized mica) through a vapor phase deposition method. DNA then can be immobilized electrostatically to this surface. Unfortunately, this technique results in surfaces that either have to be used immediately or require storage under argon and are active for only about one month.

Silanization can also be accomplished from the fluid phase either through a dip coating process or by spin coating. This method can result in root-mean-square (RMS) roughness of about 0.7+/−2 nm (see Perrin, Langmuir 13, 2557-2563, 1997, incorporated herein by reference), however, the reproducibility of the surface roughness and composition from these wet chemistry methods is unreliable. Spin casting methods are time consuming and result in low throughput. Further difficulties arise with this technique of surface modification because it is critical to prepare the surfaces in anhydrous conditions in order to avoid polymerization of the silane that may result in piles as high as 200 nm which prevent imaging of most biological molecules. See Lyubchenko, Journal of Biomolecular Structural Dynamics 9, 589-606, 1992, incorporated herein by reference.

Another difficulty with using electrostatic forces to immobilize biomolecules to a solid substrate is the necessity to control the buffer conditions during the AFM imaging process. It is critical to control the buffer pH and electrolyte concentration in order to retain the protein or biomolecule adsorbed on the surface during imaging. Further, the buffer used for imaging also defines the force and therefore the resolution with which the AFM cantilever can probe these molecules. Understanding and accommodating these effects requires a highly trained user. See Muller, Biophysical Journal 76, 1101-1111, 1999, incorporated herein by reference.

Another method that has been used to image proteins with AFM is to embed the protein in a lipid membrane and adsorb this protein lipid mixture to a mica surface. This technique has been used with great success with purple membrane by Muller and to image symmetry folds in proteins; see Moller, Biophysical Journal 77, 1150-1158, 1999, incorporated herein by reference. However, this immobilization technique results in a majority of the protein being embedded in the membrane leaving it inaccessible to probing with the AFM. Further, not all proteins are compatible with this sample preparation method. Therefore, this technique is limited to a specific class of proteins. Proteins have also been studied by AFM by preparing a 2D crystal of the protein. This method requires weeks for sample preparation and results in molecules that are only adsorbed to a surface for imaging. See Muller, EMBO Journal 16, 2547-2553, 1997, incorporated herein by reference.

Although experienced AFM users have had successes with imaging biological molecules, users of commercially available AFMs and corresponding cantilever tips have had problems with repeatability while imaging biological molecules mainly due to the high forces required to image with relatively large commercial cantilevers. Present techniques used to immobilize biomolecules to surfaces for imaging with the AFM use non-covalent binding to a surface. The molecules are simply adsorbed to a surface. With these immobilization techniques, a biomolecule can be imaged by AFM, but often the image cannot be reproduced because the tip has disrupted the binding between the molecule and the solid substrate during imaging. The forces required for imaging result in physical removal of the biological molecules from the surface during AFM imaging, in particular, when the molecule is not covalently attached or is adsorbed to the surface. The forces imparted to the biological molecule during AFM imaging can be reduced; however, this results in lower resolution measurements. In addition, often molecules adsorbed to a surface will dissociate from the surface to be in solution to decrease the overall free energy of the system.

Some users have solved this problem by modifying a commercial AFM or preparing special cantilevers to use for their experiments; see Viani, Nature Structural Biology 7, 644-647, 2000, incorporated herein by reference. Unfortunately, this requires very specialized knowledge or instrumentation.

Plasma deposition is a method by which a reactive gas is introduced to a surface and reacts directly with the surface such that the properties of the surface are altered. Reviews of production of plasmas and plasma-assisted deposition of organic or inorganic layers can be found in “Fundamentals of Plasma Chemistry” in “Technology and Application of Plasma Chemistry” J R Holahan and A Bell, Wiley, NY 1974 and H. Suhr, Plasma Chemistry, Plasma Process, 3(1), 1, 1983, incorporated herein by reference. A surface altered by the method of plasma deposition is referred to as a plasma modified substrate.

Forms of plasma deposition are used to modify surfaces for applications in biology and medicine. Surface modifications using plasma deposition include treatment of implants or medical materials to decrease adverse reactions between them and the physiological environment they come in contact with. U.S. Pat. No. 6,632,470 describes the use of plasma energy and a reactive gas to modify surfaces of medical devices, helping them maintain integrity and not harm the environment to which the devices are exposed.

Often medical materials are inert and therefore conventional coating processes do not adhere to the material due to wetting issues. Surface modification by plasma has been used to increase surface energy and wettability of surfaces. U.S. Pat. No. 4,731,156 describes exposing a surface to ammonia and oxygen in a plasma gas to create a wettable surface on a fluoropolymer.

Many different types of materials can be coated with plasma deposition. For example, a method to modify the surface of pyrolitic carbon to help increase adhesion with a polymer is described in U.S. Pat. No. 6,372,283. Pyrolitic carbon is used as a medical implant material because of its high wear resistance. Unfortunately, pyrolitic carbon is not biocompatible. Therefore, implanted medical devices made of pyrolitic carbon are coated with polymers to increase reliability during long-term exposure to blood. Plasma deposition on pyrolitic carbon is used to deposit a silicon-containing film to increase adhesion to a polymer coating.

Another example of surface modification by plasma deposition is described in U.S. Pat. No. 6,379,741 which discloses the use of plasma deposition to change the surface properties of HMWPE and UHMWPE to lower friction and improve wear resistance for use in artificial hips.

What is needed is a better sample surface for AFM imaging of biomolecues. The sample surface should have low roughness and it should present chemical groups that covalently bind to biomolecules or standard linker molecules. Sample surfaces should have long shelf lives so that they can be stored and shipped. In addition it would be desirable to make sample surfaces in a batch process for mass production.

### SUMMARY

According to an aspect of the invention, a surface suitable for imaging biomolecues comprises a substrate to which a bifunctional crosslinker layer has been applied such that biomolecules can be immobilized on the surface for measurement by atomic force microscopy. For the purposes of this application, the term immobilized refers to binding of a biomolecule to a surface with sufficient strength to allow the biomolecule to be imaged by a scanning probe microscope at least two times without being dislodged. In the preferred embodiment, it is highly desirable that the molecule be bound tightly enough to allow repeated imaging without substantial damage. It is important to note that the concept of immobilization does not require that the molecule be fastened so rigidly to the surface that no motion of the biomolecule is observed. In fact, it may be desirable for certain applications to specifically allow somewhat looser immobilization to allow motions of the biomolecule that are essential to its function.

It is preferable that the surface have a root-mean-square surface roughness of less than three nanometers, although roughness less than five or ten nanometers is suitable in certain situations. Preferred bifunctional crosslinkers include (3-aminopropyl) trimethoxysilane; (3-aminopropyl) triethyoxysilane; an alkene terminated by an amine group; or an alkyl terminated by an amine group

According to an aspect of the invention a process for making a surface for probe microscopy comprises the steps of exposing a substrate surface to an oxygen plasma; a methane plasma; a methanol plasma; and, a bifunctional crosslinker plasma.

According to an aspect of the invention a process for imaging a biomolecule, comprises the steps of: depositing a bifunctional crosslinker onto a substrate by plasma deposition; binding a biomolecule to the bifunctional crosslinker; and, using an atomic force microscope to image the biomolecule while it is bound to the bifunctional crosslinker on the surface of the substrate. An intermediate linker may be used to bind the biomolecule, for example a protein, to the bifunctional crosslinker.

### BRIEF DESCRIPTION OF THE DRAWINGS

The drawings are heuristic for clarity. The foregoing and other features, aspects and advantages of the invention will become better understood with regard to the following descriptions, appended claims and accompanying drawings in which:

FIG. 1 is a schematic diagram of the layers of a plasma modified substrate for use in AFM.

FIG. 2 is a schematic diagram of the surface of a plasma modified substrate for use in AFM.

FIG. 3 is a flow chart of steps in a plasma deposition process for modifying a substrate for use in AFM.

FIG. 4 is a chart of process parameters used in a plasma deposition process for modifying a substrate for use in AFM.

FIG. 5 is a schematic diagram of a plasma process chamber used in a plasma deposition process for modifying a substrate for use in AFM.

FIG. 6 shows a chemical schematic of a bifunctional crosslinker and a table of possible constituents of the crosslinker.

### DETAILED DESCRIPTION

The atomic force microscope (AFM) is a powerful tool that is used to image biomolecules and other small objects. AFM has advantages over other forms of microscopy including high spatial resolution and the possibility of imaging biomolecules in their native state.

Important aspects of an AFM imaging experiment are the physical and chemical properties of the substrate surface upon which a biomolecule to be imaged lies. Physically, the surface must be smooth. Root-mean-square surface roughness less than three nanometers is preferred for high quality images. In some applications, a high quality image could be obtained on a surface with root-mean-square roughness as great as five, or even ten, nanometers. Chemically, the surface should expose chemical groups that bind covalently to biomolecules or standard linker molecules such as glutaraldehyde.

We have developed a novel substrate for scanning probe microscopy that has a smooth surface, is easy to bind proteins to, and has a long shelf life so that sample substrates may be stored and shipped to distant locations. Without long shelf life it is impractical to offer prepared sample substrates for sale. Further, it is more efficient if many substrates with prepared surfaces may be produced in one batch.

We have achieved these novel capabilities by using a plasma deposition process to deposit bifunctional crosslinkers to the substrate. Herein a bifunctional crosslinker is defined as a chemical agent containing two chemically reactive groups available for binding. The bifunctional crosslinker thus serves as a bridge or connector between two chemical structures and joins them to create a single, unified structure. The case in which the two chemically reactive groups of the bifunctional crosslinker are similar or identical defines a homobifunctional crosslinker. A heterobifunctional crosslinker is a bifunctional crosslinker in which the two chemically reactive groups are dissimilar and bind two different types of chemically reactive groups.

According to an aspect of the invention, flat substrates such as silicon wafers, are chemically modified in a plasma deposition process. Plasma drives chemical reactions on the surface of the substrates rapidly. The result of the plasma process is a substrate with a very smooth and chemically active bifunctional crosslinker layer on its surface. The bifunctional crosslinker layer readily forms covalent bonds with biomolecules or standard linker molecules that attach to biomolecules. Biomolecules covalently attached to the substrate surface via the bifunctional crosslinker layer are suitably prepared for AFM imaging. The bifunctional crosslinker layer has low surface roughness, long shelf life and may be applied to many substrate samples in parallel in a plasma processing chamber. Further, coatings created by plasma deposition are highly reproducible.

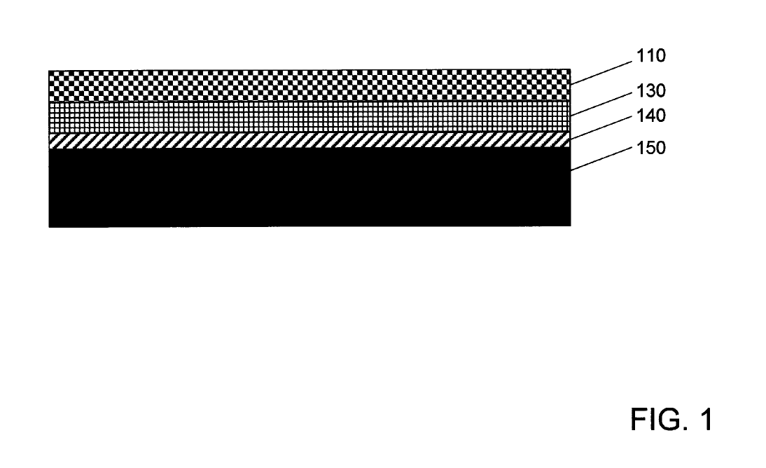

FIG. 1 is a schematic diagram of the layers of a plasma modified substrate for use in AFM. The diagram shows chemical layers deposited in a plasma deposition process. In FIG. 1, substrate 150 is preferably a solid substrate such as silicon, mica or a polymer substrate. Polished silicon 111-oriented wafers are preferred as substrates because, compared to silicon 100-oriented wafers, they have more available chemical bonds. However, many other materials including mica, glass, polymers and other materials can also be suitable as substrate 150 depending on the requirements for flatness, cost, optical transparency and other factors. Substrate 150 is first cleaned with an oxygen plasma process to remove unwanted organics and other contaminants. Next, hydrocarbon layer 140 is created on substrate 150 through a methane plasma process. Layer 140 serves as an organic tie layer.

In the preferred embodiment layer 130, containing functional hydroxyl groups, is created on layer 140 preferably by methanol (water or peroxide) plasma deposition. The purpose of layer 130 is to increase silane binding efficiency during the deposition of subsequent layers by creating active hydroxyl groups at the surface.

Layer 110 preferably comprises a bifunctional crosslinker such as (3-aminopropyl) trimethoxysilane; (3-aminopropyl) triethyoxysilane; an alkene terminated by an amine group; an alkyl terminated by an amine group; or, another crosslinker. The key requirement of this bifunctional crosslinker is that it has at least two reactive groups. One reactive group binds to layer 130 (or to a surface with an equivalent function) and another reactive group is available for binding to a protein or biomolecule. The structure shown in FIG. 1 is suitable for use as a surface to which biomolecules may be attached for AFM imaging experiments. The bifunctional crosslinker serves to covalently connect biomolecules to the substrate. At the same time the crosslinker layer is extremely smooth and has root-mean-square surface roughness less than about three nanometers. This level of smoothness is desirable for high quality AFM imaging, especially of smaller proteins and biomolecules. Surfaces with higher roughness make it more difficult to distinguish biomolecules from the substrate background. However a plasma modified substrate with root-mean-square roughness of as much as five or even ten nanometers can be used for applications to image larger biomolecules or viral capsids for example.

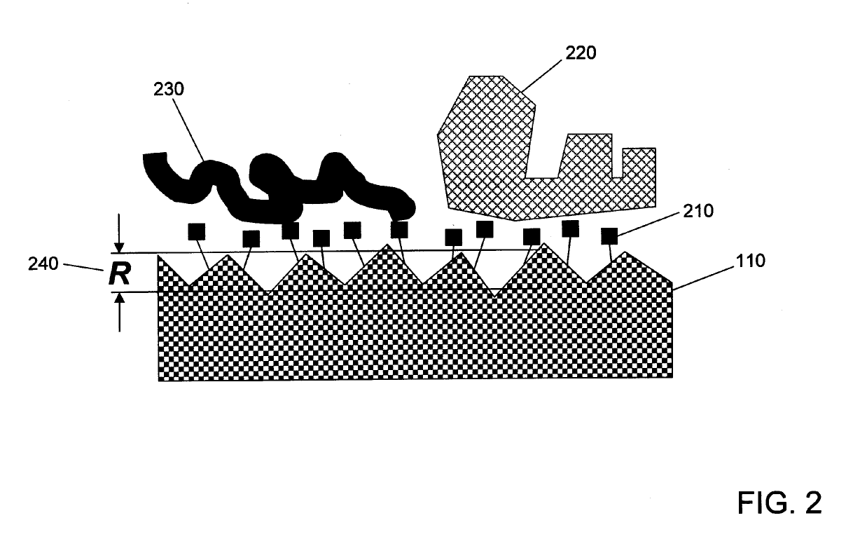

FIG. 2 is a schematic diagram of the surface of a plasma modified substrate for use in AFM. Details of the substrate surface such as its roughness and connection to biomolecules are illustrated schematically. In the figure, layer 110 is the bifunctional crosslinker layer of FIG. 1. Although the figures are not drawn to scale, layer 110 is shown magnified in FIG. 2 compared to FIG. 1 so that the RMS surface roughness R (item 240) is apparent. In FIG. 2 item 230 is a DNA molecule while item 220 is a protein molecule. Molecules 210 are optional intermediate linker molecules of, as an example, glutaraldehyde. Glutaraldehyde and other linkers are commonly used to attach biomolecules to surfaces. They are conveniently used in conjunction with a bifunctional surface layer, but are not required.

Although FIG. 2 is not drawn to scale it can still be appreciated from the figure that AFM imaging of biomolecules, such as molecules 230 and 220, would not be possible if the RMS surface roughness R (item 240) were significantly larger than the overall dimensions of the biomolecules. The best AFM images are obtained when the dimensions of the molecules or objects of interest are larger than the roughness of the surface upon which they are resting.

In FIG. 2, bifunctional layer 110 exposes chemically active groups such as amino, carboxyl, hydroxyl, cyano, alkoxy, or nitro groups on its surface. Other chemically active groups that could be exposed by a bifunctional crosslinker layer are thiol, maleimide, aldehyde, or halogen groups. It is preferred that the bifunctional crosslinker expose amino groups, but all the other chemical moieties mentioned are also desirable. The chemically active groups mentioned above readily form covalent bonds with biomolecules such as DNA, proteins and viruses.

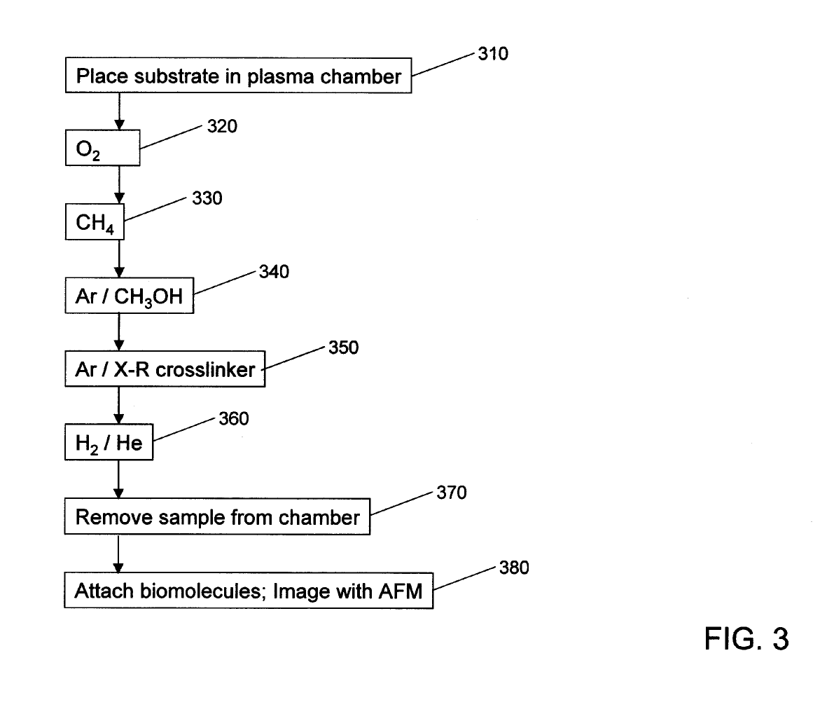

FIG. 3 is a flow chart of steps in a plasma modification process for preparing a substrate for use in AFM. The flow chart of FIG. 3 outlines a plasma deposition process for modifying the surface of a substrate. A substrate is placed in a plasma chamber. Several plasma deposition processing steps involving different reactive gases, flow rates, process times, pressures and power densities are performed. Subsequently the substrate is removed from the chamber and stored until biomolecules are attached to it for imaging by AFM.

In FIG. 3, step 310 comprises placing an appropriate sample substrate into the process chamber of a plasma processing machine. According to an aspect of the invention one of the advantages of plasma processing is that many substrates may be placed in a single plasma process chamber simultaneously for parallel or batch processing.

Step 320 is a cleaning step to prepare the substrate surface for further processing. In step 320 oxygen plasma is created in the chamber and has the effect of removing unwanted molecules from the substrate surface. In step 330 methane plasma is created in the process chamber. Methane plasma creates a hydrocarbon coating on the surface of the substrate. In step 340 methanol plasma is created in the chamber. Step 340 creates activated hydroxyl groups in the hydrocarbon coating created in step 330. Step 350 is the deposition of a bifunctional crosslinker. After the bifunctional crosslinker layer is deposited, step 360 is a hydrogen-helium quenching step which is used to quench free radicals on the surface.

The coated substrate sample is removed from the chamber in step 370. At this point the sample may be stored indefinitely or used in an AFM imaging experiment. Step 380 is the attachment of biomolecules to the bifunctional crosslinker surface layer on the substrate in preparation for AFM imaging.

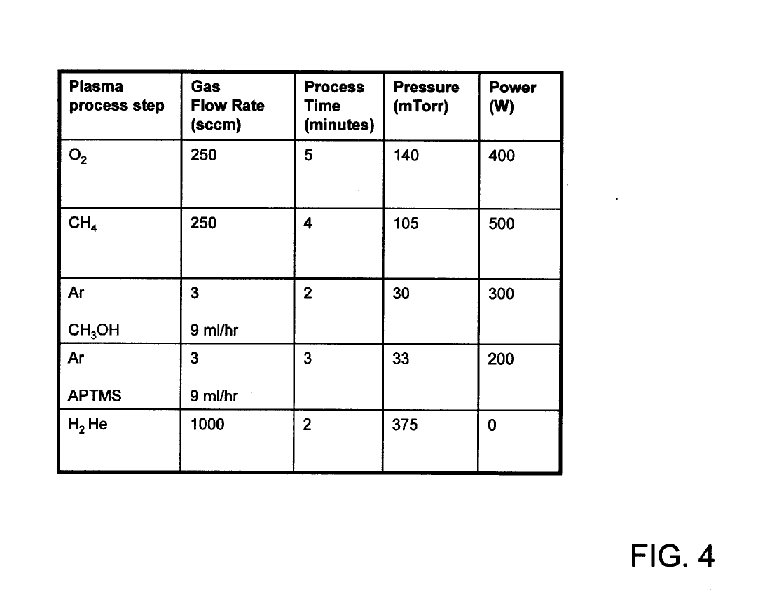

FIG. 4 is a chart of process parameters used in the steps of a preferred plasma modification process for preparing a substrate for use in AFM. The O₂, CH₄, Ar/CH₃OH, Ar/APTMS and H₂He plasma process steps listed in the chart correspond to steps 320, 330, 340, 350 and 360 respectively in FIG. 3. Each plasma process step is characterized by gas flow rate, process time, pressure and power. For example, the oxygen plasma cleaning step corresponds to an oxygen flow rate of 250 sccm for 5 minutes at 140 mTorr with 400 Watts of RF energy applied to the plates in the plasma process chamber. The process parameters shown in FIG. 4 are preferred; however, other process parameters will work. For example, the surface may be exposed to the crosslinker plasma for between 1 and 10 minutes and the flow rate of the bifunctional crosslinker may be between 1 and 100 milliliters per hour injected into an argon gas flowing between 0.1 and 10 standard cubic centimeters per minute. Parameter values outside these ranges will also work in different situations.

In the Ar/CH₃OH and Ar/APTMS steps an argon plasma is created and CH₃OH or APTMS is injected into the plasma. The liquid flow rates are reported in ml/hr. For example, the Ar/CH₃OH step corresponds to an argon gas flow rate of 3 sccm for 2 minutes at 30 mTorr with 300 Watt of RF energy applied to the plates in the plasma process chamber. During the step, CH₃OH is injected into the Ar plasma at 9 ml/hr. “APTMS” means (3-aminopropyl) trimethoxysilane although other crosslinkers such as (3-aminopropyl) triethoxysilane; an alkene terminated by an amine group; an alkyl terminated by an amine group; or another crosslinker, could also be used.

The parameters illustrated in FIG. 4 have been used successfully to create suitable surfaces for AFM imaging of biomolecules. However, it will be readily appreciated that parameter variations are permitted according to an aspect of the invention and that none of the parameters is considered critical. When experimenting to find the best parameter values, attention should be paid to the power used in the step in which the crosslinker is deposited. If too little power is used the deposition is unsuccessful; nothing happens. If too much power is used, the crosslinker molecules may be destroyed. In the case of APTMS, too much power may fractionate the molecule so that the amino functionality is lost.

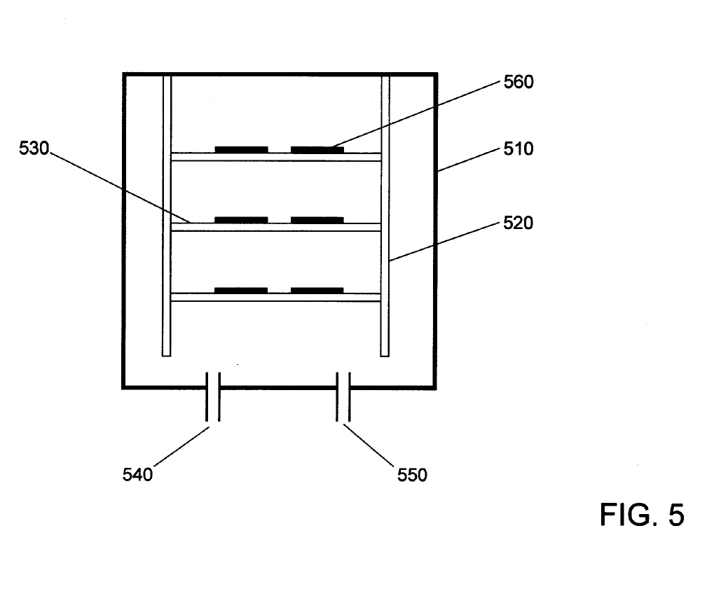

FIG. 5 is a schematic diagram of a plasma process chamber used in a plasma modification process for preparing a substrate for use in AFM. In the figure, 510 is the plasma process chamber. Insulating support structures 520 hold shelves 530 upon which sample substrates such as substrate 560 rest. Inlet 540 and outlet 550 ports allow gases to enter and exit the chamber. RF voltages are applied between alternating shelves 530 and/or the shelves and the grounded chamber 510.

In actual test runs of the processes described above, shelves 530 were approximately 12 by 15 inches and the spacing between shelves was approximately 5 inches. The frequency of the applied RF voltages was 13.56 MHz. It will be appreciated that different plasma chamber geometries may require adjustment of the parameters described in, and in connection with, FIG. 4.

It is apparent from the figure that many samples may be prepared in parallel. The possibility of preparing many samples in a parallel batch mode is an important advantage over conventional processes according to an aspect of the invention.

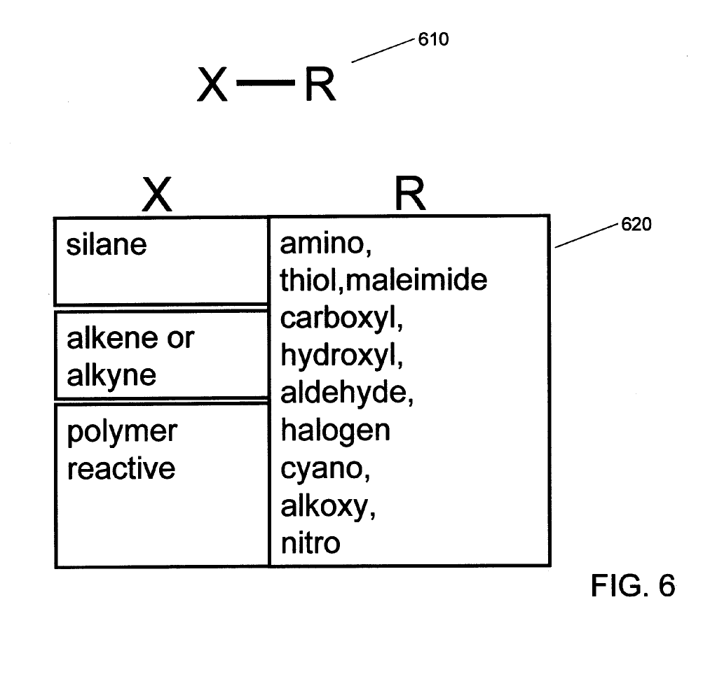

FIG. 6 shows a chemical schematic of a bifunctional crosslinker and a table of possible constituents of the crosslinker. The bifunctional crosslinker molecular structure 610 is that of a molecule with different functional groups X and R at each end. As shown in the table 620, X could be a silane, alkene, alkyne, or polymer reactive group. R is a functional group such as amino, thiol, maleimide, carboxyl, hydroxyl, aldehyde, halogen, cyano, alkoxy, nitro or other group reactive to biomolecules.

As one skilled in the art will readily appreciate from the disclosure of the present invention, processes, machines, manufacture, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, means, methods, or steps. Although aspects of the invention have been described in connection with the use of heterobifunctional crosslinkers, it is to be understood that they are not limited to use with heterobifunctional crosslinkers but can be extended to cover use with homobifunctional or other bifunctional crosslinkers.

While the invention has been described in connection with what are presently considered to be the most practical and preferred embodiments, it is to be understood that the invention is not limited to the disclosed embodiments and alternatives set forth above, but on the contrary is intended to cover various modifications and equivalent arrangements included within the scope of the following claims.

What is claimed is:

1. A surface for imaging biomolecules, comprising: a substrate; and, a bifunctional crosslinker layer applied to the substrate by plasma deposition such that biomolecules can be immobilized for measurement by atomic force microscopy.

2. The surface of claim 1 wherein the root-mean-square surface roughness of the crosslinker layer is less than ten nanometers.

3. The surface of claim 2 wherein the root-mean-square surface roughness of the crosslinker layer is less than five nanometers.

4. The surface of claim 3 wherein the root-mean-square surface roughness of the crosslinker layer is less than three nanometers.

5. The surface of claim 1 wherein the substrate is silicon.

6. The surface of claim 5 wherein the bifunctional crosslinker is (3-aminopropyl) trimethoxysilane; (3-aminopropyl) triethyoxysilane; an alkene terminated by an amine group; or an alkyl terminated by an amine group.

7. The surface of claim 5 wherein one end of the bifunctional crosslinker is a siloxane, alkene or alkyne group.

8. The surface of claim 7 wherein one end of the bifunctional crosslinker is a chemical group capable of forming a covalent bond with a biomolecule.

9. The surface of claim 8 wherein the chemical group is amino, carboxyl, hydroxyl, cyano, alkoxy, or nitro.

10. The surface of claim 1 wherein the substrate is mica.

11. The surface of claim 10 wherein one end of the bifunctional crosslinker is an alkene, alkyne or a siloxane group.

12. The surface of claim 11 wherein one end of the bifunctional crosslinker is a chemical group capable of forming a covalent bond with a biomolecule.

13. The surface of claim 12 wherein the chemical group is amino, carboxyl, hydroxyl, cyano, alkoxy, or nitro.

14. The surface of claim 1 wherein the substrate is a polymer.

15. The surface of claim 14 wherein one end of the bifunctional crosslinker can form a covalent bond with the polymer.

16. The surface of claim 1 5 wherein one end of the bifunctional crosslinker is a chemical group capable of forming a covalent bond with a biomolecule.

17. The surface of claim 16 wherein the chemical group is amino, carboxyl, hydroxyl, cyano, alkoxy, or nitro.

18. A process for making a surface for probe microscopy, comprising the steps of exposing a substrate surface to: an oxygen plasma; a methane plasma; a methanol plasma; and, a bifunctional crosslinker plasma.

19. The process of claim 18 wherein the surface is exposed to the crosslinker plasma for a time, and at a flow rate, pressure and power density effective to produce a crosslinker surface root-mean-square roughness less than ten nanometers.

20. The process of claim 19 wherein the surface is exposed to the crosslinker plasma for a time, and at a flow rate, pressure and power density effective to produce a crosslinker surface root-mean-square roughness less than five nanometers.

21. The process of claim 20 wherein the surface is exposed to the crosslinker plasma for a time, and at a flow rate, pressure and power density effective to produce a crosslinker surface root-mean-square roughness less than three nanometers.

22. The process of claim 21 wherein the surface is exposed to the crosslinker plasma for between 1 and 10 minutes, the flow rate of the bifunctional crosslinker is between 1 and 100 milliliters per hour injected into an argon gas flowing between 0.1 and 10 standard cubic centimeters per minute.

23. A process for imaging a biomolecule, comprising the steps of: depositing a bifunctional crosslinker onto a substrate by plasma deposition; binding a biomolecule to the bifunctional crosslinker; and, using an atomic force microscope to image the biomolecule while it is bound to the bifunctional crosslinker on the surface of the substrate.

24. The process of claim 23 wherein the biomolecule is bound indirectly to the bifunctional crosslinker through the use of an intermediate linker.

25. The process of claim 24 wherein the biomolecule is a protein.
